(19) United States
(12) Patent Application Publication
(10) Pub. No.: US 2022/0211079 A1
(43) Pub. Date: Jul. 7, 2022

(54) Omega-3 Beverage

(71) Applicant: Lynxit Sport Nutrition AS, Oslo (NO)

(72) Inventors: Janne Sande Mathisen, Oslo (NO); Henrik Mathisen, Oslo (NO)

(21) Appl. No.: 17/608,999

(22) PCT Filed: May 4, 2020
(86) PCT No.: PCT/EP2020/062326

§ 371 Date: Nov. 5, 2021

(30) Foreign Application Priority Data
May 7, 2019 (NO) 20190588
Dec. 30, 2019 (NO) 20191535

(51) Int. Cl. A23L 2/02; A23L 2/52; A23L 33/105; A23L 33/12; A23L 35/00

(52) U.S. Cl. CPC A23L 2/02; A23L 2/52; A23L 35/10; A23L 33/12; A23L 33/105

(57) ABSTRACT

The present invention provides a beverage in the form of an oil-in-water emulsion comprising a marine oil, black seed oil and fruit juice, wherein the beverage comprises at least 0.4 μg of a mixture of thymoquinone and thymohydroquinone per ml of beverage.

### FIELD OF THE INVENTION

The present invention relates to new compositions comprising a combination of marine oil and black seed oil and emulsions comprising said compositions. The present invention also relates to compositions and emulsions for prophylactic or therapeutic applications.

### BACKGROUND

There is a growing global demand for marine oils rich in long chain omega-3 polyunsaturated fatty acids (LC n-3 PUFAs), with a steadily increasing market for human consumption of such “omega-3” oils. The demand is driven by the documented prophylactic and therapeutic effects of eicosapentaenoic acid (EPA) and docosahexaenoic acid (DHA).

Omega-3 fatty acids are essential fatty acids that have diverse biological effects in human health and disease. Omega-3 fatty acids play important roles in the body as components of the phospholipids that form the structures of cell membranes, and DHA, in particular, is especially high in the retina, brain, and sperm (M. E Surette et al 2008).

In addition to their structural role in cell membranes, omega-3s (along with omega-6s) provide energy for the body and are required for the synthesis of eicosanoids. Eicosanoids are signalling molecules that have similar chemical structures to the fatty acids from which they are derived. They have wide-ranging functions in the body's cardiovascular, pulmonary, immune, and endocrine systems. There is extensive clinical evidence of medical benefits of omega 3 fatty acids (DHA and EPA), e.g. on the circulatory system and metabolic health, the nervous system and mental health, immune functions, infant development, eye diseases, and preventing and improving chronic diseases in oncology and immunology (NIH, National Centre for complementary and integrated health; ‘Omega 3 fatty acids’ Jun. 6, 2018). DHA and EPA have also been demonstrated to (1) improve insulin sensitivity and metabolic syndrome/diabetic conditions (B. B. Albert et al October 2014, Nature—Scientific report, H. Gao et al., July 2017, Lipids, Health and Disease), (2) improve the lymphatic system, (Huixia Ren et al, October 2016, FASEB), (3) improve sleep (P. Montgomery et al., 2014, Journal of Sleep research), (4) improve muscle health and prevent loss of muscle function and size (A. Z. Laila et al, April 2017, Journal of Aging), (5) improve muscle recovery and muscle metabolic functions (S. Jeromson et al, November 2015, Marine drugs), (6) improve recovery after brain injuries e.g., concussions, and after surgery (F. Gomez-Pinilla et al, November 2011, Surg. Neurol.), and (7) promote healing of burns and wounds (A. C. Brown et al, 2003, Stress and Nutrition). There is also some evidence linking omega 3 fatty acids to key functions responsible for delaying the aging process (O. S. Ademowo et al., December 2017, Biogerontology)

The essential omega-3 fatty acids of marine oils are prone to oxidation in presence of air, leading to an unpleasant flavour (“fishy” or rancid flavour) and smell, which can render the oils unsuitable for human consumption and destroy the nutritional value of their essential fatty acid (primarily the DHA and EPA) components.

Lipid oxidation is a well-studied and highly complex series of chemical reactions. These reactions generate highly reactive oxidation products that can interact with DNA and proteins, leading to cell damage. Lipid oxidation of LC n-3 PUFA is a known cause for food deterioration through changes in structure, nutritional value, colour, flavour and smell. In addition to the documented instability of marine oils during process and storage, it has been shown in in vitro and animal studies that such oils can oxidize further during passage through the GIT12-14. Partly oxidized marine oil was shown to yield higher levels of further oxidation products under gastric and intestinal conditions compared to fresh (less oxidised) oil.

Both physical and chemical strategies are currently used to minimize oxidation during processing and storage of marine oils prior to ingestion. The available methods are only partly effective, and none of them can prevent oxidation in presence of air (oxygen). Marine oils are far more difficult to stabilize than unsaturated vegetable oils, as the fatty acids (DHA and EPA) have a higher degree of unsaturation and are thus more prone to oxidation. The characteristic smell and taste of oxidised omega-3 fatty acids from fish oils can be detected in much lower concentrations than in other fats, such as vegetable oils (Frankel 2005, Olsen 2005).

An advantageous and practical manner in which to obtain sufficient amounts of marine oils, as well as other beneficial nutrients, in the diet, is by incorporating them in nutritional beverages, such as sports beverages and similar.

Beverages comprising marine oils as oil-in-water emulsions are well-known and disclosed in for instance WO 2007/064222 A1 and WO 2009/120091 A1. The manufacture and packaging process of such beverages commonly requires specialized steps to avoid oxidation of the marine oils.

It is of continuous interest to find new ingredients having nutritional, therapeutic and/or prophylactic properties and which are suitable for use in nutritional beverages based on marine oil in water emulsions.

During the manufacture of nutritional beverages based on a marine oil in water emulsion, the beverages must undergo a heat treatment, i.e. pasteurization, to obtain a product having a sufficiently long shelf life. Consequently, new ingredients suitable for use in these beverages will have to be stable in water at high temperatures.

Black seed oil is a composition having known therapeutic and prophylactic properties. Black seed oil is distilled or cold pressed from the seeds of the black cumin (Nigella sativa) plant which belongs to the ranunculus family (Ranunculaceae). The black cumin plant is native to south and southwestern Asia, the Mediterranean and Africa. Black seed oil is also commonly called black cumin seed oil.

The plant has been grown for centuries and its aromatic and flavourful seeds have been applied both as a spice and as an herbal medicine.

Black seed oil has recently become increasingly popular through the documentation of its various health benefits that may be achieved at relatively low dosage. Black seed oil benefits include better blood lipids balance, improved immune function (fighting infections and reducing inflammation), reduced risk of certain cancers, and improved cognitive performance. Other benefits include supporting liver health, combating type-2 diabetes, improving skin health, supporting eye health, and supporting hair growth.

The potential of black seed oil in preventing lipid oxidation of fish oil has previously been described and examined (Lutterodt et al., LWT—Food Science and Technology 43, 2010, 1409-1413). The amount of lipid oxidation was investigated by measuring the electron spin resonance (ESR) intensity of a 1:1 mixture of fish oil and black seed oil. However, no mention is made of whether the anti-oxidative effect of the black seed oil was sufficient to prevent the formation of unpleasant taste and/or smell or whether the constituents of the black seed oil were stable.

Black seed oil contains thymoquinone (TQ), a compound suggested to play a significant and major role in its proven health benefits. Thymoquinone is also the major contributor to the anti-oxidative property observed in the oil-in-oil mixture of black seed oil and fish oil (Khither et al., Annual Research & Review in Biology, 25(5), 1-9, 2018). Anti-oxidative and/or therapeutic effects may also be obtained by thymohydroquinone (THQ), the reduced form of thymoquinone (Staniek and Gille BMC Pharmacology 2010, 10(Suppl 1):A; Burčul et al., Current Medicinal Chemistry 25, March 2018). However, the amount of THQ in black seed oil is commonly very low (Tiruppur Venkatachallam S K, Pattekhan H, Divakar S, Kadimi U S. Chemical composition of Nigella sativa L. seed extracts obtained by supercritical carbon dioxide. J Food Sci Technol. 2010; 47(6):598-605). Other antioxidant compounds present in black seed oil, such as carvone, carvacrol and p-cymene may also contribute to the health benefits of black seed oil.

The use of black seed oil and/or thymoquinone in nutritional beverages comprising water is not known. A likely reason is the fact that the stability of thymoquinone in aqueous solutions is very poor and it rapidly undergoes severe degradation at room temperature (Salmani et al. Molecules 2014, 19, 5925-5939).

As discussed above, an advantageous and practical way to obtain sufficient amounts of marine oils, as well as other beneficial nutrients, in the diet, is by incorporating them in nutritional beverages. Thus, there is a need for new beverages comprising beneficial nutrients including marine oils, in which said marine oils are protected from detrimental oxidation.

Also, it is increasingly recognised that formulations that combine certain nutrients can provide synergistic health effects beyond those provided by each individual formulation constituent. Specifically, there is an opportunity for new compositions for achievement and maintenance of good health combining the beneficial effects of low oxidised marine oil and black seed oil, with the potential of achieving synergistic health benefits.

### SUMMARY OF THE INVENTION

The present invention is defined by the attached set of claims and in the following:

In a first aspect, the present invention provides a beverage in the form of an oil-in-water emulsion comprising a marine oil, black seed oil and fruit juice, wherein the beverage comprises at least 0.4 μg of a mixture of thymoquinone (TQ) and thymohydroquinone (THQ) per ml of beverage. The thymoquinone and thymohydroquinone are obtained from thymoquinone and thymohydroquinone naturally present in the black seed oil. The black seed oil is preferable a cold pressed black seed oil.

In an embodiment, the beverage comprises at least 0.4 μg of thymohydroquinone (THQ) per ml of beverage.

In an embodiment of the beverage, at least 50% of the thymohydroquinone originates from thymoquinone naturally present in the black seed oil, i.e. from thymoquinone present in the black seed oil before the black seed oil forms part of the beverage. Preferably, at least 60%, 70% or 80% of the thymohydroquinone (THQ) originates from thymoquinone (TQ) naturally present in the black seed oil.

The remaining thymohydroquinone may preferably originate from thymohydroquinone naturally present in the black seed oil.

In an embodiment, the beverage comprises thymoquinone (TQ) and thymohydroquinone (THQ) in a weight/weight ratio of 1:1 to 1:100, preferably 1:10 to 1:60.

In an embodiment, the beverage has been pasteurised at a temperature of at least 60° C., preferably at a temperature of at least 90° C. or at least 100° C. The higher temperatures allow for increased shelf life.

In an embodiment of the beverage, the fruit juice is obtained by mixing water and a fruit concentrate. The fruit juice may be obtained from any suitable fruit or berry.

A black seed oil suitable for use in the beverage may preferably comprise at least 0.3 mg/ml of thymoquinone or at least 0.3 mg/ml of a mixture of thymoquinone and thymohydroquinone.

In an embodiment of the beverage, the ratio of black seed oil to marine oil is from 2:1 to 1:20. Optionally, the ratio of black seed oil to marine oil may be in the ranges of 1:1 to 1:20, 1:2 to 1:20 or 1:2 to 1:10. The amount of marine oil is preferably present in excess of the amount of black seed oil.

In an embodiment, the beverage according to the invention comprises 0.5-15% by weight of the marine oil based on the total weight of the beverage. Optionally, the beverage may comprise 1-10%, 2-8% or 2-6% by weight of the marine oil based on the total weight of the beverage.

In an embodiment, the beverage according to the invention comprises 0.05-7% by weight of the black seed oil based on the total weight of the beverage. Optionally, the beverage may comprise 0.1-3% or 0.2-2.0% by weight of the black seed oil based on the total weight of the beverage.

In an embodiment of the beverage, the marine oil is selected from the group of fish oil, such as cod liver oil, salmon and trout oil, and krill oil.

In an embodiment, the beverage according to the invention comprises 60-95% by weight of water based on the total weight of the beverage, preferably 70-90%.

In an embodiment, the beverage according to the invention comprises an emulsifier.

In an embodiment, the beverage according to the invention is for use as a prophylactic or therapeutic preparation.

Thus, an object of the present invention is to provide a new beverage which is beneficial for maintenance of good health combining the beneficial effects of low oxidized marine oil and black seed oil, with the potential of achieving synergistic health benefits.

The term “marine oil” is in the present invention intended to mean any edible oil comprising the omega-3 fatty acids EPA and DHA. A “marine oil” may be any oil rich in omega-3 fatty acids, e.g. fish oil such as cod liver oil, oil from high-fat fish like salmon, trout, mackerel, herring and/or sardines, as well as seal oil or krill oil. However, in the present application, the term “marine oil” is also intended to comprise e.g. any potential vegetable oil fortified with an amount of EPA/DHA or obtained from a genetically modified plant source able to produce EPA/DHA. A marine oil will preferably comprise at least 5% w/w or 8% w/w of DHA and/or at least 3% or 5% w/w of EPA.

The terms “EPA”, “eicosapentaenoic acid”, “DHA” and “docosahexaenoic acid” are intended to comprise any suitable derivative of the acids, such as in the form of alkyl esters, phospholipids and phosphatidyl cholines.

Preferably, the marine oil is a low oxidized marine oil without the characteristic smell or taste of fish. The level of oxidation given as the totox value (2 times the peroxide value (PV) added with the anisidin value (AV)) should be low, i.e. below 20, preferably below 15, and most preferably below 10. A suitable totox value is 6.

Furthermore, the content of omega-3 fatty acids in the marine oil should be at least 10%, 15%, preferable at least 20%, most preferably at least 30% by weight.

The black seed oil may be any commercially available black seed oil produced from seeds of the black cumin plant (Nigella sativa). The black seed oil is preferably cold pressed and comprises at least 3 mg/ml of thymoquinone or at least 3 mg/ml of a mixture of thymoquinone and thymohydroquinone.

The beverage of the invention is prepared by mixing together marine oil, black seed oil and fruit juice, as well as other suitable optional ingredients.

The beverage may be used as such but may preferably be filled in air tight and sealed containers under inert atmosphere in absence of light. They may be stored refrigerated or at ambient temperatures.

The beverage may be stabilized by suitable additives such as natural proteins, other polymers, and/or emulsifiers.

The beverage may have a wide range of rheologies and textures, preferably such as a smoothie-like or juice-like nutritional beverage. In an embodiment, the beverage according to the invention has an absolute viscosity of below 150 kg/(m*s) at room temperature.

The water of the beverage may be obtained by any combination of water, juice or juice concentrates from berries, fruits, herbs, and/or vegetables, and/or tea, or any combinations thereof. In this context the term juice, nectar and extract are used synonymously. The juice may be selected from any suitable juice including, but not limited to, goji, bilberry, blueberry, gooseberry, strawberry, blackberry, raspberry, elderberry, red and black currants, lingonberry, rowanberry, cranberry, cloudberry, sea buckthorn, acai berry, cherry, pomegranate, peach, apple, pear, oranges, grapefruit, mandarin and lime, nectarine, apricot, peach and plum, banana and mango, watermelon, rockmelon and honeydew melon, kiwi, passionfruit, tomato, carrot, beetroot, pumpkin, sweet potato, and/or cabbage, or any combinations thereof.

In the context of the present application, the term fruit juice is intended to encompass juice of fruits and berries.

The juice may be fresh pressed juice or diluted from juice concentrate. The juice concentrate may be diluted according to the manufacturer's guidelines or diluted to obtain a final juice with a higher or lower juice concentrate concentration than instructed by the manufacturer.

The content of water or juice present in the beverage according to the invention is adjusted to balance the content of the remaining ingredients. To obtain an easily drinkable beverage, the amount of water may be within the range of 60-95 weight % relative to the total weight of the beverage, preferably within the range of 70-90 weight %.

The beverage may be stabilized by suitable additives such as natural proteins, other polymers, and/or emulsifiers.

For the preparation of a beverage according to the invention, any suitable food grade emulsifier or combinations of suitable food grade emulsifiers, may be used. The term “emulsifier” in this document is employed to cover compounds that assist the production of an emulsion by lowering the oil-water interfacial tension, such as lecithin, as well as compounds that contribute to stabilisation of the emulsion once it is formed, such as high molecular weight proteins or polysaccharides. Additional suitable emulsifiers include, but are not limited to, pectin, lecithin, esters of monoglycerides, sugar esters, proteins, hydrolysed proteins, peptides, natural or modified amino acids, natural or modified polysaccharides such as xanthan gums, alginates, celluloses, starches, hyaluronic acid, chitosan, etc., or any combinations thereof.

The beverage according to the invention may further comprise flavouring agents, sweeteners, thickening and/or gelling agents, or any combinations thereof. As such the beverage may be given any desirable taste and a desirable consistence.

The beverage according to the invention may comprise further additives such as proteins including hydrolysed proteins and peptides, both of animal and plant origin, amino acids or amino acid derivatives such as leucine, beta alanine, creatine, BCAA (branched chain amino acids), GABA (gamma-aminobutric acid), L-glutamine, L-theanine, citrulline, natural or modified polysaccharides such as xanthan gums, alginates, celluloses, starches, hyaluronic acid, choline, chitosan etc., stilbenoides such as pterostilbene, isothiocyanates such as sulforaphane, herbs such as; valerian root, lemon balm, ashwagandha, ginseng, maca, rhodiola, holy basil, hormones such as melatonin, vitamin D3, antioxidants such as curcuminoids, resveratrol, pycnogenol, Q10, lipoic acid, astaxanthin, lycopene, lutein, quercetin, glutathione, polyphenols, tocopherols and flavonoids, cannabinoids, minerals such as magnesium, selenium, potassium, iron, calcium, zinc, vitamins such as vitamin E, D, B, K and C and/or preservatives, or any combinations thereof. A particularly advantageous further additive is carnitine.

In an embodiment, the beverage according to the invention comprises 0.1-2% by weight of carnitine based on the total weight of the beverage. In an embodiment, the beverage according to the invention comprises 0.05-4%, preferably 0.3-2%, by weight based on the total weight of the beverage.

In a second aspect, the present invention provides an air-tight beverage container containing a beverage according to the first aspect, wherein the beverage is pasteurised.

In a third aspect, the present invention provides a process for the manufacture of a beverage according to any of the preceding claims, the process comprises the steps of:
emulsifying a mixture comprising a marine oil, black seed oil and fruit juice to obtain a beverage;
pasteurising the beverage at a temperature of at least 60° C., preferably at least 90 or 100° C.; and
filling the beverage into a suitable air-tight beverage packaging in a substantially oxygen-free environment.

In a fourth aspect, the present invention provides a method of obtaining a beverage according to any embodiment of the first aspect, wherein the beverage comprises thymoquinone and thymohydroquinone in a ratio of 1:1 to 1:50, comprising the step of:
emulsifying a mixture comprising a marine oil, black seed oil and fruit juice.

In a fifth aspect, the present invention provides a method of obtaining a beverage comprising black seed oil, wherein the beverage comprises thymohydroquinone only obtained from the black seed oil and the amount of thymohydroquinone in the beverage is larger than the amount of thymoquinone originally present in the black seed oil (i.e. present in the black seed oil prior to obtaining the beverage), the method comprising the step of:
emulsifying a mixture comprising black seed oil and fruit juice.

In a sixth aspect, the present invention provides a method of obtaining a beverage comprising black seed oil, wherein the beverage comprises thymohydroquinone obtained from reduction of thymoquinone originally present in the black seed oil, the method comprising the step of:
emulsifying a mixture comprising black seed oil and fruit juice.

In a seventh aspect, the present invention provides a method of converting (i.e. reducing) thymoquinone in black seed oil to thymohydroquinone, the method comprising the step of:
emulsifying a mixture comprising black seed oil and fruit juice.

In the fifth to seventh aspects of the invention, the mixture may comprise a marine oil, and may optionally provide a beverage according to any of the embodiments of the first aspect of the invention.

The fifth to seventh aspects of the invention may comprise a further step of pasteurising the emulsified mixture.

In the present patent application, the term “beverage” is intended to define a drink that is produced to sell to people.

### DETAILED DESCRIPTION OF THE INVENTION

It has surprisingly been found that the addition of black seed oil to a nutritional beverage based on a marine oil in water emulsion significantly delays or prevents the generation of oxidation products that are associated with “fishy” smell and unpalatable flavours, even upon prolonged exposure to air (oxygen).

The superior effect is particularly unexpected in view of the known instability of thymoquinone in aqueous solutions, since thymoquinone is believed to be the major compound responsible for the anti-oxidative properties of black seed oil.

Surprisingly, thymoquinone appears to be stable when present in a beverage comprising an oil in water emulsion, although a major part of the thymoquinone is reduced to thymohydroquinone, see below. Even more unexpected is the fact that both thymoquinone and thymohydroquinone are stable under heat treatment of the beverage before packaging.

Consequently, the use of black seed oil in the inventive nutritional beverage is highly advantageous, both in that the marine oils are protected from oxidation and in that the therapeutically beneficial compounds thymoquinone and its reduced form thymohydroquinone are stabilized by the marine oil in water emulsion, thus allowing thymoquinone and thymohydroquinone to be ingested in an easy manner through a beverage.

Thus, it has been found an efficient way to stabilize and possibly reverse the oxidation process to reduce the oxidation levels of marine oils, ensuring the beneficial effect of low oxidized marine oils, while at the same time providing a nutritional beverage comprising thymoquinone and thymohydroquinone in a stable form.

The present invention has made possible a beverage beneficial for achievement and maintenance of good health combining the beneficial effects of low oxidized marine oil and black seed oil. The marine oil and the black seed oil may even work synergistically.

The inventive beverage may advantageously comprise additional beneficial ingredients or compounds.

Carnitine (β-hydroxy-γ-N-trimethyl-aminobutyric acid, 3-hydroxy-4-N,N,N-trimethylaminobutyrate) is a particularly preferred additional ingredient/compound. Carnitine is a quaternary ammonium compound involved in metabolism in most mammals, plants and some bacteria. Carnitine is the generic expression for a number of compounds that include L-carnitine, acetyl-L-carnitine, and propionyl-L-carnitine. It is most accumulated in cardiac and skeletal muscles as it accounts for 0.1% of its dry matter. Carnitine is involved in transporting fatty acids across the mitochondrial membrane, by forming a long chain acetyl carnitine ester and being transported by carnitine palmitoyl transferase I and carnitine palmitoyl transferase II. Carnitine also plays a role in stabilizing acetyl-CoA and coenzyme A. During the past 30 years, dietary supplementation with carnitine has been widely studied in a number of conditions including exercise performance, cardiovascular health, epilepsy, autism, diabetes/metabolic syndrome, overweight, fertility etc. The results from the different trials are conflicting and one of the main arguments against carnitine supplementation has been lack of sufficient uptake in the target tissue, e.g. muscle.

The manner in which carnitine is formulated or supplemented seems to be highly relevant for the bioavailability and utilization of this compound. The incorporation of carnitine in the beverage according to the invention is believed to provide a superior bioavailability of carnitine.

The beverage according to the invention may also comprise other additives such as proteins, including hydrolysed proteins and peptides, both of animal and plant origin, amino acids or amino acid derivatives such as leucine, beta alanine, creatine, BCAA (branched chain amino acids), GABA (gamma-aminobutyric acid), L-glutamine, L-theanine, citrulline, natural or modified polysaccharides such as xanthan gums, alginates, celluloses, starches, hyaluronic acid, choline, chitosan etc., stilbenoides such as pterostilbene, isothiocyanates such as sulforaphane, herbs such as; valerian root, lemon balm, ashwagandha, ginseng, maca, rhodiola, holy basil, hormones such as melatonin, vitamin D3, antioxidants such as curcuminoids, resveratrol, pycnogenol, Q10, lipoic acid, astaxanthin, lycopene, lutein, quercetin, glutathione, polyphenols and flavonoids, cannabinoids, minerals such as magnesium, selenium, potassium, iron, calcium, zinc, vitamins such as vitamin E, D, B, K and C and/or preservatives, or any combinations thereof.

The beverage according to the invention may be prepared according to procedures well-known in the art, for example as disclosed in WO 2007/064222 A1. However, it should be noted that due to its excellent stability towards marine oil oxidation, the inventive beverage may be manufactured by standard commercial processes commonly used for beverages not comprising easily oxidized marine oils.

Thus, a major advantage of the beverage according to the invention is that its production is not dependent on any specialized processes to avoid oxidation of the marine oil. Further, as discussed below, the beverage has an excellent shelf life even at room temperature storage.

### EXEMPLARY EMBODIMENTS

Exemplary beverages according to the invention are described in the following:

### Example 1—Beverage Comprising Marine Oil and Black Seed Oil Added Plant Proteins

| | Pr 100 g | |
|---|---|---|
| Marine oil | 2.0 | g |
| Black seed oil | 300 | mg |
| Plant proteins (from Sunflower seeds, Chia seeds | 3.6 | g |
| and Lupin seeds), | | |
| Pectin | 0.4 | g |
| Blueberry concentrate | 4.0 | g |
| Goji berry concentrate | 6.0 | g |
| Elderberry concentrate | 1.5 | g |
| Strawberry concentrate | 3.5 | g |
| Water | 78.7 | g |

### Example 2—Beverage Comprising Marine Oil and Black Seed Oil Added Whey Proteins and Hydrolysed Collagen

| | Pr 100 g | |
|---|---|---|
| Marine oil | 4.0 | g |
| Black seed oil | 850 | mg |
| Plant proteins (from Sunflower seeds, Chia seeds | 1.5 | g |
| and Lupin seeds), | | |
| Whey protein concentrate | 4.0 | g |
| Natural Peach aroma | 0.2 | mg |
| Collagen hydrolysed | 15 | g |
| Pectin | 0.3 | g |
| Blueberry concentrate | 3.0 | g |
| Goji berry concentrate | 7.0 | g |
| Apple concentrate | 1.5 | g |
| Strawberry concentrate | 5.0 | g |
| Water. | 71.15 | g |

### Example 3—Beverage Comprising Marine Oil, Black Seed Oil and

| | Pr 100 g |
|---|---|
| Marine oil | 2.5 g |
| Black seed oil | 0.9 g |
| Plant proteins (from Sunflower and Chia seeds), | 3.6 g |
| L-Carnitine | 0.2 g |
| Pectin | 0.4 g |
| Goji berry concentrate | 6.0 g |
| Elderberry concentrate | 1.5 g |
| Strawberry concentrate | 3.5 g |
| Blueberry concentrate | 4.0 g |
| Water | 77.4 g |

### Example 4—Beverage Comprising Marine Oil, Black Seed Oil and Carnitine

| | Pr 100 g | |
|---|---|---|
| Marine oil | 3.0 | g |
| Black seed oil | 0.85 | g |
| L-Carnitine | 0.25 | g |
| Lecitin | 3.0 | g |
| Cinnamon aldehhyde | 10 | mg |
| Pectin | 0.35 | g |
| Black currant concentrate | 4.0 | g |
| Pomegranate concentrate | 2.0 | g |
| Apple concentrate | 6.0 | g |
| Natural Raspberry aroma | 0.2 | mg |
| Water | 80.34 | g |

### Example 5—Beverage Comprising Marine Oil, Black Seed Oil and Carnitine, Added Nicotinamide, Curcumin and Vitamin D3

| | Pr 100 g | |
|---|---|---|
| Marine oil | 4.0 | g |
| Black seed oil | 2.0 | g |
| Acetyl -L-Carnitine | 0.4 | g |
| Whey proteins | 2.5 | g |
| Pectin | 0.4 | g |
| Bilberry concentrate | 3.0 | g |
| Goji berry concentrate | 2.0 | g |
| Elderberry concentrate | 1.0 | g |
| Apple concentrate | 5.0 | g |
| Cinnamon aldehyde | 2 | mg |
| Sweet apple aroma | 0.3 | mg |
| Curcumin | 0.3 | g |
| Vitamin D3 | 5 | μg |
| Nicotinamide | 0.3 | g |
| Water | 79.5 | g |

### Example 6—Beverage Comprising Marine Oil, Black Seed Oil and Carnitine

| | Pr 100 g |
|---|---|
| Marine oil | 2.4 g |
| Black seed oil | 0.31 g |
| L-Carnitine | 0.2 g |
| Whey proteins | 6.0 g |
| Pectin | 0.38 g |
| Collagen | 3.3 g |
| Black currant concentrate | 2.5 g |
| Apple concentrate | 6.5 g |
| Pear concentrate | 5.5 g |
| Water | 73.0 g |

### Example 7—Beverage Comprising Marine Oil, Black Seed Oil and Carnitine

| | Pr 100 g | |
|---|---|---|
| Water | 74.57 | g |
| Marine oil | 2.55 | g |
| Black cumin oil | 0.6 | g |
| Pectin | 0.3 | g |
| Hydrolysed Collagen | 4.00 | g |
| Whey protein concentrate | 2.00 | g |
| Guardian rosemary extract 201 | 0.02 | g |
| Guardian toco 50 IP, antioxidant | 0.01 | g |
| Nicotinamide | 0.10 | g |
| Carnitine | 0.15 | g |
| Pear juice concentrate | 7.50 | g |
| Black current concentrate | 4.00 | g |
| Apple juice concentrate, sweet, normal acid | 4.00 | g |
| Natural Peach aroma Frey & Lau | 0.2 | g |

### Example 8—Beverage Comprising Marine Oil, Black Seed Oil and Carnitine

| | Pr 100 g |
|---|---|
| Water | 71.16 g |
| Marine oil | 2.70 g |
| Black cumin oil | 0.31 g |
| Pectin (Genu Pectin YM-115-L) | 0.38 g |
| Whey protein concentrate | 6.50 g |
| Sunflower protein powder | 0.10 g |
| Hydrolysed collagen | 2.80 g |
| Guardian rosemary extract 201 | 0.02 g |
| Guardian toco 50 IP, antioxidant | 0.01 g |
| Carnitine | 0.20 g |
| Pear juice concentrate | 5.70 g |
| Blackcurrant juice concentrate | 3.50 g |
| Apple juice concentrate, sweet, normal acid | 6.40 g |
| Natural Raspberry aroma IFF | 0.22 g |

### Example 9—Beverage Comprising Marine Oil and Black Seed Oil

| | Pr 100 g | |
|---|---|---|
| Water | 70.66 | g |
| Marine oil | 2.7 | g |
| Black cumin oil | 0.31 | g |
| Pectin | 0.38 | g |
| Whey protein concentrate | 9.50 | g |
| Sunflower protein powder | 0.3 | g |
| Guardian rosemary extract 201 | 0.02 | g |
| Guardian toco 50 IP, antioxidant | 0.01 | g |
| Vitamin D3 # | | |
| Pear juice concentrate | 5.70 | g |
| Blackcurrant juice concentrate | 3.80 | g |
| Apple juice concentrate, sweet, normal acid | 6.40 | g |
| Natural Raspberry aroma IFF | 0.22 | g |

### Example 10—Beverage Comprising Marine Oil and Black Seed Oil Added Oat Beta Glucans and Proteins, Choline Bitartrate and Vitamin D3

| | Pr 100 g | |
|---|---|---|
| Marine oil | 4.0 | g |
| Black seed oil | 850 | mg |
| Oat beta glucans | 3.0 | g |
| Whey protein concentrate | 1.0 | g |
| Natural Peach aroma | 0.2 | mg |
| Choline bitartrate | 0.2 | g |
| Pectin | 0.15 | g |
| Black current concentrate | 3.0 | g |
| Pear concentrate | 5.0 | g |
| Apple concentrate | 4.5 | g |
| Vitamin D3 | 5 | micrograms |
| Water. | 78 | g |

The exemplary beverages were prepared according to well-known procedures as described above, subjected to heat treatment and filled in closed (air tight) aseptic containers, i.e. single dose containers of 250 ml (Tetrapak carton).

Marine Oil

Commercial Fish Oils:
CodMarine 70/100 TG—Batch no: PF9470118) produced by PharmaMarine, Ålesund, Norway. The oil was analyzed to have an omega-3 content of 25%, of which DHA amounted to 11% and EPA to 9%, and a totox value of 6 (PV: 0 and ANv: 6).
(Omega FF100-1—Batch no: 833018-77) produced by Vesteraalens as, Havnegata 17, 8400 Sortland. The oil was analyzed to have an omega-3 content of 25.3%, of which DHA amounted to 11.3% and EPA to 8.3%, and a totox value 1.6 (PV: 0.3 and AV: 1)

Black Seed Oil

Cold pressed ‘Black Cumin’ oil from Egypt, supplied by All Organic Treasures, Germany. (Lot no: 1804A0751.) The oil was analysed by the producer and comprises 0.35 mg/ml thymoquinone (TQ) and thymohydroquinone (THQ) in a ratio of 60:1.

Remaining Ingredients were Supplied by:

Strawberry and Elderberry juice concentrate delivered by BerryPharma gmba.

Bilberry, Blueberry and Goji berry concentrate delivered by Storms as.

Pectin delivered by Alimenta

Protein powders; Sunflower, Chia, Lupin and Coconut, delivered by All Organic

Treasures AOL

Cinnamon aldehyde delivered by Storms as

Nicotinamide and L-Carnitine delivered by Lonza

Vitamin D3 delivered by GoJohnsen

Hydrolyzed Collagen delivered by Junca Gelatine

Whey protein concentrates delivered by Arla Foods

Peach Aroma delivered by Einar Willumsen

Apple Aroma delivered by Storms as

Raspberry Aroma delivered by IFF

Curcumin delivered by Naturex

VitaCholin from Balchem

PromOat from Lantmannen

Sensory Analysis of Mixtures of Fish Oil and Black Seed Oil Upon Storage in the Presence of Air

As discussed above, the potential of black seed oil in preventing lipid oxidation of fish oil has previously been described and examined (Lutterodt et al., LWT—Food Science and Technology 43, 2010, 1409-1413). The amount of lipid oxidation was determined indirectly by measuring the electron spin resonance (ESR) intensity of a 1:1 mixture of fish oil and black seed oil, i.e. by measuring the presence of free radicals. However, no mention is made of whether the anti-oxidative effect of the black seed oil was sufficient to prevent the formation of unpleasant taste and/or smell.

The characteristic smell and taste of oxidised omega-3 fatty acids from marine oils can be detected in much lower concentrations than in other fats, such as vegetable oils (Frankel, Lipid Oxidation 2^{nd} edition, Elsevier February 2005, Olsen et al. Journal of Agric. Food Chem. January 2005). The measurement of such low concentrations with classical chemical analytical methods can be challenging, and sensory analysis has in many cases proven superior to these methods for the early detection of fish oil oxidation (Frankel, Lipid Oxidation 2^{nd} edition, Elsevier February 2005,).

Volatile secondary oxidation products from omega-3 fatty acids have strong flavours even at very low concentrations (Frankel, Lipid Oxidation 2^{nd} edition, Elsevier February 2005), and such flavours can render marine oil products less marketable and lead to poor product reputation and loss of sales (Olsen et al., Journal of Agric. Food Chem. January 2005)

Fatty acids can be auto-oxidized, photo-oxidized, or “enzymatically” oxidized. Auto-oxidation happens when polyunsaturated fatty acids are exposed to air (oxygen), photo-oxidation upon exposure to UV light, and “enzymatic oxidation” through enzymatic (lipase) hydrolysis of triglycerides yielding free fatty acids that are particularly sensitive to oxidation in contact with air (oxygen) (Frankel, Lipid Oxidation 2^{nd} edition, Elsevier February 2005).

To investigate whether black seed oil is in fact capable of sufficiently preventing lipid oxidation of fish oil, such that no unpleasant taste and/or smell is formed, a preliminary study was performed.

In the preliminary study, samples of pure fish oil and pure black seed oil was compared to samples containing mixtures of fish oil and black seed oil. The samples were subjected to various temperatures (4 and 20° C.) and stirring to maximize their interaction with oxygen. Blinded sensory evaluation of the samples, i.e. smell and taste, was performed by three judges.

The preliminary study revealed that the addition of black seed oil to fish oil significantly delays or prevents the generation of oxidation products that are associated with unwanted smell and flavour, even upon prolonged exposure to air (oxygen). Surprisingly, even low amounts of black seed oil (about 10 weight % relative to the fish oil) was effective in preventing oxidation.

Although black seed oil was shown to prevent oxidation of fish oil in an oil in oil mixture, the applicant was reluctant to use black seed oil in a water-based beverage since thymoquinone, the major compound believed to be responsible for the anti-oxidative effect, as well as various therapeutic and prophylactic properties, of black seed oil, is known to be highly unstable in water (Salmani et al. Molecules 2014, 19, 5925-5939).

Stability Test of an Exemplary Beverage

To evaluate whether black seed oil was suitable for oxidative protection of a marine oil in a water-based beverage, the exemplary beverage 6 was prepared. The beverage was pasteurized and packaged in 250 ml air tight containers suitable for consumers.

Containers with beverage from two different batches were stress tested by being stored at a temperature of 40° C. for 4 weeks.

The beverages were analysed for M0233 Volatile Compounds (JAOCS, Vol. 82, no. 2, 2005, 97-203) before and after the stress test. The analysis revealed that no oxidation products were formed during the stress test.

Containers with exemplary beverages 7 and 9 were also opened to evaluate the stability of the beverage towards oxygen/air over time. The opened containers were stored at 23° C. (i.e. room temperature) for one week. The sensory properties of the beverages were then evaluated by a panel of three persons. No unpleasant taste and/or smell was detected.

Analysis of Exemplary Beverages for Content of Thymoquinone (TQ) and Thymohydroquinone (THQ)

The exemplary beverages 7, 8 and 9 were analyzed for the presence of thymoquinone (TQ) and its reduced form thymohydroquinone (THQ) after storage at room temperature for different time periods. The analysis was performed by SINTEF Industry, Department of Biotechnology and Biomedicine. The compounds of interest were extracted from 10 ml of the respective sports drinks with 1 ml of dichloromethane, by vigorous mixing followed by phase separation by centrifugation. The lower phase (dichloromethane) was dried by addition of excess NaSO₄ and analyzed by GC-MS with electron impact positive ionization, in selected ion monitoring (SIM) mode, following the m/z 164 (TQ) and 166 (THQ) molecular ions. Quantification was performed against a standard curve of TQ and THQ, run in duplicate, in dichloromethane ranging from 0.1 to 100 μg/ml. The final concentrations—corrected for sample concentration upon liquid-liquid extraction—in the sports drinks as found by this approach were:

| Beverage | Storage | TQ | THQ |
|---|---|---|---|
| no. | (months) | (μg/ml) | (μg/ml) |
| 7 | 6 | 0.078 | 1.90 |
| 8 | 1 | 0.035 | 0.43 |
| 9 | 3 | 0.032 | 0.62 |

Matrix effects may have had an impact on the consistency of the results, but it is clear that thymoquinone and thymohydroquinone are stabilized in the inventive beverages, even at room temperature over an extended period of time. It is noted in the analysis report that TQ/THQ were highly unstable in methanol, i.e. more than 80% degradation over three days.

The large amount of thymohydroquinone was surprising but is believed to be the result of thymoquinone being reduced by help of oxidoreductases present in the fruit juices of the beverage (K. Jensen, B. L. Moller (2010) Plant NADPH-cytochrome P450 oxidoreductases, Phytochemistry, 71 (2-3), 132-141). Many of these oxidoreductases, e.g. NADPH-cytochrome P450 oxidoreductase, are known to reduce quinones, including thymoquinone (Armutcu, F., Akyol, S., & Akyol, O. (2018). The interaction of glutathione and thymoquinone and their antioxidant properties. Electronic Journal of General Medicine, 15 (4), em59).

The results show that the marine oils present in the beverage are protected from oxidation during storage in a substantially oxygen free environment (i.e. in the closed container) and even for a significant time period when in contact with air. Further, this protective effect is present even when the beverage has been subjected to heat treatment (i.e. pasteurizing conditions) before packaging.

Thymoquinone (TQ) is believed to be the major anti-oxidative compound in pure black seed oil, as well as having various therapeutic/prophylactic properties.

Thymohydroquinone (THQ) is however known to be a more potent anti-oxidant than thymohydroquinone (K. H. Khalife & G. Lupidi (2007) Non-enzymatic reduction of thymoquinone in physiological conditions, Free Radical Research, 41:2, 153-161; Armutcu, F., Akyol, S., & Akyol, O. (2018). The interaction of glutathione and thymoquinone and their antioxidant properties. Electronic Journal of General Medicine, 15 (4), em59). In addition, THQ is also known for various therapeutic/prophylactic properties. However, the amounts of THQ in pure black seed oil is very low. Consequently, the conversion of TQ to THQ in the inventive beverage is believed to be highly advantageous in that it provides a more potent anti-oxidant. The high amounts of THQ may explain the excellent stability and shelf life of the inventive beverage.

The above results show that after an initial reduction of an amount of thymoquinone, both thymoquinone and thymohydroquinone are stabilized in the beverage according to the invention and can provide an anti-oxidative effect. Consequently, the results show that the beverage according to the invention can provide thymoquinone and thymohydroquinone in a stable form.

The ability of black seed oil to prevent deterioration of marine oils in an oil-in-water beverage, even in the presence of oxygen, is a novel and unexpected finding. Even more surprising is the fact that the invention can provide consumers with a beverage comprising thymoquinone/thymohydroquinone in a stable form. The latter entails that the many therapeutic and/or prophylactic effects of thymoquinone and thymohydroquinone may easily be achieved by use of a palatable and nutritious beverage.

1. A beverage in the form of an oil-in-water emulsion comprising a marine oil, black seed oil and fruit juice, wherein the beverage comprises at least 0.4 μg of a mixture of thymoquinone and thymohydroquinone per ml of beverage.

2. A beverage according to claim 1, wherein the beverage comprises at least 0.4 μg of thymohydroquinone per ml of beverage.

3. A beverage according to claim 1 or 2, wherein the beverage comprises thymoquinone and thymohydroquinone in a ratio of 1:1 to 1:100.

4. A beverage according to claim 1 or 2, wherein the beverage has been pasteurised at a temperature of at least 60° C.

5. A beverage according to claim 1 or 2, wherein the fruit juice is obtained by mixing water and a fruit concentrate.

6. A beverage according to claim 1, wherein the ratio of black seed oil to marine oil is from 2:1 to 1:20.

7. A beverage according to claim 1 or 2, comprising 0.5-15% by weight of the marine oil based on the total weight of the beverage.

8. A beverage according to claim 1 or 2, comprising 0.05-7% by weight of the black seed oil based on the total weight of the beverage.

9. A beverage according to claim 1, comprising 60-90% by weight of water based on the total weight of the beverage, preferably 65-85%.

10. A beverage according to claim 1 wherein the marine oil is selected from the group of fish oil, such as cod liver oil, salmon and trout oil, and krill oil.

11. A beverage according to claim 1, wherein the content of omega-3 fatty acids in the marine oil is at least 10% by weight, preferably at least 20%, most preferably at least 30%.

12. A beverage according to claim 1, having an absolute viscosity of below 150 kg/(m*s) at room temperature.

13. A beverage according to claim 1, comprising an emulsifier.

14. A process for the manufacture of a beverage according to claim 1, the process comprises the steps of:
emulsifying a mixture comprising a marine oil, black seed oil and fruit juice;
pasteurising the emulsified mixture at a temperature of at least 60° C.; and
filling the emulsified mixture into a suitable air-tight beverage packaging in a substantially oxygen-free environment.

15. A method of obtaining a beverage according to claim 1, wherein the beverage comprises thymoquinone and thymohydroquinone in a ratio of 1:1 to 1:50, comprising the step of:
emulsifying a mixture comprising a marine oil, black seed oil and fruit juice.

16. A method of obtaining a beverage comprising black seed oil, wherein the beverage comprises thymohydroquinone only obtained from the black seed oil and the amount of thymohydroquinone in the beverage is larger than the amount of thymoquinone originally present in the black seed oil, the method comprising the step of:
emulsifying a mixture comprising black seed oil and fruit juice.

17. A method of obtaining a beverage comprising black seed oil, wherein the beverage comprises thymohydroquinone obtained from reduction of thymoquinone present in the black seed oil, the method comprising the step of:
emulsifying a mixture comprising black seed oil and fruit juice.

18. A method of reducing thymoquinone in black seed oil to thymohydroquinone, the method comprising the step of:
emulsifying a mixture comprising black seed oil and fruit juice.
